(19) United States
(12) Patent Application Publication
(10) Pub. No.: US 2003/0021445 A1
(43) Pub. Date: Jan. 30, 2003

(54) Method for optically monitoring the environment of a moving vehicle to determine an inclination angle

(76) Inventors: Markus Larice, Karlskron (DE); Werner Steiner, Schrobenhausen (DE)

Correspondence Address: FASSE PATENT ATTORNEYS, P.A., P.O. BOX 726, HAMPDEN, ME, 04444-0726, US

(21) Appl. No.: 10/180,995

(22) Filed: Jun. 24, 2002

Related U.S. Application Data
(63) Continuation-in-part of application No. PCT/EP00/12087, filed on Dec. 1, 2000.

(30) Foreign Application Priority Data
Dec. 23, 1999 (DE) 199 62 491.7

(51) Int. Cl. G06K 9/00

(52) U.S. Cl. 382/104; 348/148; 340/933

(57) ABSTRACT

The environment outside of a moving vehicle is optically monitored to acquire image information including a number of image points representing image objects or features of the outside environment. The time variation of the respective positions of the image points is analyzed to determine an inclination angle of the vehicle relative to a level horizontal plane. The optical information can be acquired by an optical camera or detector with which the vehicle has already been equipped for obstacle recognition or spacing distance control. The optically determined inclination angle is used to verify the plausibility of a rotation angle signal provided by a gyroscopic rotation rate sensor. An occupant protection device is triggered only if the two separately determined values of the inclination angle are at least approximately equal to each other and exceed a prescribed threshold.

### CROSS-REFERENCE TO RELATED APPLICATIONS

This application is a Continuation-In-Part under 35 U.S.C. §120 of our copending PCT International Application PCT/EP00/12087, filed on Dec. 1, 2000. The PCT International Application was published in a language other than English. The entire disclosure of the PCT International Application is incorporated herein by reference.

### PRIORITY CLAIM

This application claims the priority under 35 U.S.C. §119 of German Patent Application 199 62 491.7, filed on Dec. 23, 1999, the entire disclosure of which is incorporated herein.

### FIELD OF THE INVENTION

The invention relates to a method for optically monitoring the surrounding environment, and of determining an inclination angle, of a vehicle moving along a roadway.

### BACKGROUND INFORMATION

Various different methods for optically monitoring the environment surrounding a moving vehicle are already known in a variety of different applications. Such methods typically use cameras or optical detectors in order to acquire image information and thus optically monitor the surrounding environment of the motor vehicle, and particularly the area of the roadway on which the vehicle is traveling, lying directly in front of the vehicle in the normal forward travel direction, as well as side areas laterally adjoining the roadway area directly in front of the moving vehicle.

For example, the German Patent Laying-Open Documents DE 21 56 001, DE 30 01 621, and DE 197 24 496 each disclose an obstacle detection method based on such optical monitoring of the vehicle environment. German Patent Laying-Open Document 198 04 944, for example, discloses a vehicle spacing distance regulation method which uses an optical monitoring of the vehicle environment in order to regulate the spacing distance or following distance of a vehicle behind preceding vehicles. German Patent Laying-Open Publication DE 34 15 572 A1 discloses the adaptation of the measuring angle of such a monitoring arrangement dependent on the steering angle of the vehicle, while U.S. Pat. No. 3,749,197 discloses an adaptation of the slope or inclination angle of the measuring beams of such a monitoring system to the roadway, dependent on the traveling speed of the vehicle.

The patent publications DE 37 32 347 C1 and WO 99/34235 disclose methods for acquiring or recording three-dimensional spacing distance images in which a respective spacing distance information is allocated to a respective image point or pixel. While the use of an optical monitoring system and method for monitoring the interior space of a vehicle comprises a fixed reference system, i.e. the fixed frame of reference of the interior space of the vehicle, an optical monitoring of the outside environment around a moving vehicle must account for the motion of the vehicle relative to that environment.

German Patent Laying-Open Document DE 37 41 259 discloses a method and an apparatus for the autonomous steering control of a vehicle, in which the position variation of the environment relative to the vehicle is continuously measured as the vehicle travels along. Particularly, both the distance of an object in the environment, relative to the vehicle, as well as the observed angle of the object parallel to the plane of the roadway, are detected in this known monitoring method. It is also known to measure the angle of stationary objects in a plane, from the German Patent Laying-Open Document DE 37 03 904.

Furthermore, German Patent DE 196 50 629 C2 discloses a method and a system for measuring the inclination angle or tilt angle of a vehicle, including respective optical spacing distance sensors arranged at the corners of the vehicle and oriented perpendicularly downward from the vehicle to the surface of the roadway on which the vehicle is traveling. The sensors thus measure the respective distance from each respective sensor at a respective corner of the vehicle to the roadway surface. A variation of or difference among the spacing distances measured by the several sensors is used to calculate the inclination or tilt angel of the vehicle. Then, based on this calculated inclination or tilt angle, occupant protection devices, such as a roll bar, belt tensioners, and airbags, are activated. However, the optical measurement of the spacing distance or height taken perpendicularly to the ground can be subject to substantial interferences and error-inducing variations due to unevenness of the roadway.

It is also known to use sensors that are sensitive to rotation accelerations, e.g. gyro sensors, for carrying out the tilt or inclination angle measurement. However, such sensors are rather expensive and complicated, and they also lead to erroneous decisions or inclination angle determinations in boundary condition cases.

### SUMMARY OF THE INVENTION

In view of the above, it is an object of the invention to provide a simplified, yet functionally improved manner of determining a tilt or inclination angle of a moving vehicle, especially in connection with the detection of a rollover condition of the vehicle, for triggering occupant protection devices. More particularly, it is an object of the invention to provide a method and an apparatus which is simple, yet achieves an improved accuracy and a reduced error rate of the inclination angle determination. The invention further aims to avoid or overcome the disadvantages of the prior art, and to achieve additional advantages, as apparent from the present specification.

The above objects have been achieved according to the invention in a method of determining the inclination angle of a vehicle driving along a roadway. The vehicle is especially a motor vehicle such as an automobile or truck driving along a paved road as the roadway, however, the vehicle may be any type of vehicle that moves along any defined path that serves as the roadway. Most generally, the inventive method involves optically acquiring image information of an optical image of the environment surrounding the moving vehicle, and detecting image points in this image of the environment. The image information is evaluated over time, e.g. by acquiring successive sets or frames of image information over time as the vehicle moves along the roadway. Thereby, the time variation of the position of the determined image points of the acquired image information is determined and evaluated in order to derive therefrom the inclination angle of the vehicle relative to a horizontal plane or a mean plane of the surface of the roadway.

Throughout this specification, the inclination angle is always understood to be the inclination or tilt angle of the vehicle, and especially relates to the lateral inclination or tilt angle of the vehicle about its longitudinal roll axis and relative to a horizontal plane, e.g. as defined by a horizontal roadway surface.

This inclination angle could also be regarded as the roll angle. Alternatively, the inclination angle could be evaluated as the pitch angle, or tilt angle about a transverse pitch axis of the vehicle, and relative to a horizontal plane.

In the case of evaluating the roll angle as the inclination angle, preferably the image information is acquired from a field of view or angle of view oriented substantially parallel to the longitudinal axis of the vehicle in a forward direction from the vehicle. Throughout this specification, the forward direction refers to the ordinary principle forward travel direction of the vehicle. For example, the field of view in which the image information is acquired spans a certain vertical angle of view or angular range and a certain horizontal angle of view or angular range, wherein this field of view encompasses the longitudinal axis of the vehicle in the forward direction. The horizontal and vertical angular ranges of this field of view may, for example, span an angle in a range from 20° to 90°.

The image points acquired or detected in the acquired image information of the image of the surrounding environment of the moving vehicle are preferably stationary, prominent and easily ascertainable features or objects included in the image, e.g. trees, buildings, roadway signs, road structures such as bridges, the natural environmental horizon, etc. These image features or objects are especially passive features and objects that already pre-exist in the environment surrounding the vehicle, and are not active navigation beacons or any sort of active objects that actively emit a signal or the like for the purpose of active navigation of the vehicle or active involvement in the inclination angle determination.

Especially by acquiring and detecting a plurality of different image points, respectively corresponding to plural different environmental features or objects, it is possible to provide a correlation of the values respectively determined for these plural image points over time, and to analyze the time variation of the image positions of each of the plural environmental points. Thereby it is further possible to eliminate local or individual interfering influences, such as a local unevenness of the roadway. It also becomes possible to filter-out or calculate-out or otherwise eliminate the influence of the forward linear motion of the vehicle on the time variation of the ascertained locations of the image points.

Preferably, the acquired image points include or represent the natural environmental horizon, and the time variation of the position of the natural horizon in the acquired image is determined. The variations arising from the linear travel motion of the vehicle are therewith eliminated. The orientation of the detected natural horizon can be directly used to define the horizontal reference plane against which the inclination angle of the vehicle is determined. In other words, the apparent angular orientation of the detected horizon in the field of view of the acquired image can be used directly as the basis for determining the inclination angle of the vehicle.

Any known image processing software and/or hardware can be used to carry out the acquisition and evaluation of the image information in order to acquire the image points and then recognize and evaluate the change of the position of each respective image point over time. Most simply, this involves sufficiently identifying a point in the image in order to track this point as it moves to successive different apparent locations in the image over time. Moreover, the evaluation can involve image recognition, for example in order to recognize and determine the existence, the position, and the orientation of the natural environmental horizon in the image.

According to a further aspect of the invention, it is especially advantageous and preferred to carry out the above described evaluation of acquired image information for determining the inclination angle of the vehicle using an optical imaging device such as a camera or other optical detectors that already exist, i.e. have already separately been provided on the vehicle, for example for the purpose of obstacle recognition and/or vehicle spacing or following distance regulation. The image information acquired by the existing optical imaging device is simply further evaluated to also determine the inclination angle of the vehicle from the time variation of the respective positions of the detected image points. Thereby, in comparison to providing separate optical sensors for achieving this inclination angle measurement, a considerable cost savings and simplification can be achieved.

Insofar as the environmental monitoring method is carried out within an angle of view or detection angle, it is advantageous if the line of sight or orientation of this field of view is rotatable and selectively positionable about the vehicle yaw axis oriented perpendicular to the roadway surface. In this manner, the line of sight or detection direction can be adapted to the particular environmental conditions or the vehicle operating conditions or behavior at hand. For example, the field of view could be oriented laterally to the side of the vehicle, or in the rearward longitudinal direction.

The above described method of determining the inclination angle of the vehicle can be further incorporated in a method of rollover detection. Namely, the inclination angle that has been determined by the optical monitoring as described above is used to carry out a plausibility verification of the inclination angle of the vehicle as determined by a rotation rate sensor. The rotation rate sensor includes a movable mass or massive body that is mechanically deflected as a reaction to any rotational acceleration acting on the vehicle and thus acting on the rotation rate sensor. This resulting mechanical deflection of the massive body is used to determine an inclination angle of the vehicle, in any known manner. However, in the event of an extremely slow variation of the tilt or inclination angle of the vehicle, the mechanical deflection and thus the inclination angle signal emitted by such a rotation rate sensor can suffer substantial deviations from the actual vehicle inclination angle and time variation thereof. Thus, according to the invention, the above described optically determined inclination angle is combined or compared with the inclination angle determined by the rotation rate sensor, in order to test whether the inclination angle determined by the rotation rate sensor is plausible. Particularly, only when the two independently determined inclination angle values are at least approximately equal, then an occupant protection device such as an airbag, a belt tensioner, a roll-bar, or the like will be deployed. In this context, the term “at least approximately equal” means that the two inclination angle values are, for example, not more than 200 and preferably not more than 100 different from one another, or alternatively, that these values differ from one another by no more than 20% of the inclination angle value determined by the rotation rate sensor. By providing such a plausibility verification, it is possible to substantially reduce the requirements of the accuracy of each one of the inclination angle determining systems by itself, for example reducing the required accuracy of the optical inclination angle measurement as determined from the environmental image points. Thereby, the components and the overall system can be significantly simplified and reduced in cost.

A further feature of the invention involves using at least one optical sensor or detector with a line of sight oriented at an acute angle down from the forward travel direction (parallel to the longitudinal axis of the vehicle) to a point or points generally in front of the vehicle on the roadway. Since this line of sight is oriented at an acute angle, i.e. an angle less than 90°, as measured downwardly from the forward direction along the longitudinal axis of the vehicle, this line of sight or view direction for obtaining the image information is not oriented perpendicularly from the vehicle down onto the roadway surface.

When using a single optical detector or sensor in this embodiment, the acquired image information represents an arc of image points on the roadway surface in front of the vehicle. When two or more optical detectors or sensors are used, the image information provided by each detector may be simply a single image point at a location in front of the vehicle, particularly at a location at which the fixed line of sight at a fixed acute angle of the respective detector intersects the roadway surface. If the tilt or inclination angle of the vehicle relative to the plane of the roadway surface changes, then the measured distance from the respective sensor to the respective image point on the roadway surface changes. The difference of the respective measured distances, and the variation of such a difference or differences over time, and/or the divergence of such measured distances from specified nominal distances pertaining for the situation of a zero inclination angle, is used to determine the actual inclination angle of the vehicle.

The invention further provides a system or apparatus for carrying out the above methods, especially including an optical detector, an optical image information evaluating unit, a rotation rate sensor, and a signal comparison unit for comparing the signals or inclination angle information respectively provided by the rotation rate sensor and the optical detector system. The optical image evaluation unit can be adapted to carry out not only the inclination angle determination, but also an obstacle recognition evaluation and/or a travel spacing or following distance evaluation.

### BRIEF DESCRIPTION OF THE DRAWINGS

In order that the invention may be clearly understood, it will now be described in connection with example embodiments thereof, with reference to the accompanying drawings, wherein:

FIG. 1A is a schematic perspective view of a vehicle traveling along a roadway in a surrounding environment, whereby the vehicle is not inclined, i.e. has an inclination angle of zero degrees relative to a horizontal plane;

FIG. 1B is a schematic diagram representing an environment image as acquired by an optical image detector of the vehicle of FIG. 1A;

FIG. 2A is a view similar to that of FIG. 1A, but showing the vehicle having an inclination angle due to its driving onto a ramp or bump that raises one side of the vehicle relative to the other side;

FIG. 2B is a view similar to that of FIG. 1B, but showing the acquired image for the vehicle condition of FIG. 2A, with an inclination angle;

FIG. 3 is a schematic perspective view of an embodiment of the invention involving monitoring of the distance of respective points on the roadway in front of the vehicle, at a prescribed fixed angle relative to the driving direction, whereby the vehicle has an inclination angle of zero;

FIG. 4 is a view similar to that of FIG. 3, but representing the vehicle in a tilted or inclined orientation, i.e. with an inclination angle; and

FIG. 5 is a schematic block diagram of a system or arrangement for carrying out a preferred embodiment of the inventive method.

### DETAILED DESCRIPTION OF PREFERRED EXAMPLE EMBODIMENTS AND OF THE BEST MODE OF THE INVENTION

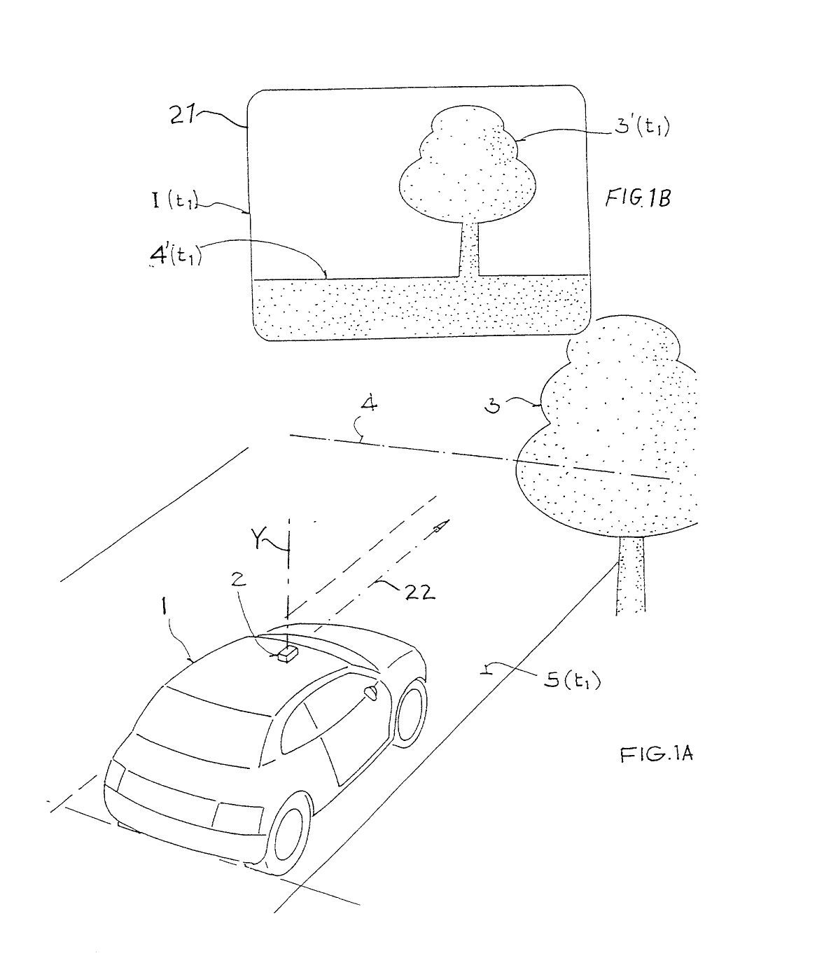

FIG. 1A schematically shows a vehicle 1 moving along a level roadway 5(t1) at a time t(1). As represented by the reference number 5(t1) of the roadway, the surface character, e.g. the inclination and the evenness thereof, varies along its length, which corresponds to a variation thereof over time with respect to the forward travel of the vehicle 1 therealong. As mentioned, at time t(1) the roadway 5(t1) is level and, particularly, horizontal.

An optical unit 2, for example comprising an optical imaging device such as any conventionally known camera or optical sensor or detector, is arranged on the vehicle 1. The optical unit 2 can be arranged on or in the vehicle 1 at any selected one of various locations, arrangements, and orientations. For example, the optical unit 2 can be arranged within the vehicle 1 behind the windshield thereof, or on the roof of the vehicle 1, or at the front end thereof, for example on or in the front bumper or incorporated in the headlights thereof. Alternatively, the optical unit or at least the optical camera or detector thereof can be arranged in the side mirrors, in a door handle, or in a blinker light.

In the preferred embodiment, the optical unit 2 is oriented with its optical axis or line of sight 22 extending parallel to the longitudinal axis of the vehicle 1 in the forward travel direction. Alternatively, the optical axis or line of sight of the optical unit 2 may be oriented a few degrees above or below a line that extends exactly parallel to the longitudinal axis of the vehicle 1, while the field of view 21, i.e. the horizontal and vertical angles of view as an angular range about the optical axis or line of sight 22, encompasses the line that would extend parallel to the longitudinal axis of the vehicle 1.

Preferably, the optical unit 2 is already pre-existent, i.e. has already previously been arranged on the vehicle 1, for example for the purpose of obstacle recognition and/or spacing distance regulation with respect to leading vehicles in front of the vehicle 1. The optical camera of the optical unit 2 acquires image information of the image I as seen in the field of view 21 of the optical unit 2, as this image varies over time. Various evaluation algorithms are then used to process and evaluate the image information in order to provide the above mentioned obstacle recognition and spacing distance values, and also the tilt or inclination angle of the vehicle 1 according to the invention.

More particularly, according to the invention, the optical unit monitors the surrounding environment of the vehicle in order to acquire image information particularly including a number of image points in the acquired image of this surrounding environment. The image points are especially points corresponding to prominent and easily distinguishable stationary features or objects 3 in the environment, such as trees, road signs, buildings, roadway structures such as bridges, and the like, as well as the natural horizon 4, which are visible in the environmental image I(t1) acquired by the optical unit 2 at time t(1) in the field of view 21 of the optical unit 2, as represented in FIG. 1B.

The features or objects 3 in the acquired image are especially passive environmental features and objects that typically exist in the environment along the roadway 5. In other words, these features and objects 3 are not active beacons that actively emit navigation, position or orientation information, and that are purposely placed along the roadway to interact with the inventive inclination angle determination system.

As mentioned above, in FIG. 1A, the vehicle 1 is traveling along a level horizontal roadway 5(t1), so that at this time t(1), the vehicle's instantaneous tilt or inclination angle α is 0. This is also verified or apparent by the position and orientation of the environmental features and objects, e.g. the image 3′ (t1) of the environmental object 3 and the image 4′ (t1) of the environmental horizon 4, with respect to the field of view 21 of the image I(t1). Namely, the optical unit 2 is oriented so that its field of view has a specified relationship to the orientation of the vehicle 1. Here, the rectangular field of view 21 of the optical unit 2 extends with its long axis parallel to the transverse pitch axis of the vehicle 1 and orthogonal to the longitudinal axis of the vehicle 1. Thus, when the image of the horizon (t1) is evaluated as extending parallel to the long axis of the field of view 21 of the acquired image I(t1), then this indicates that the transverse pitch axis of the vehicle 1 is horizontal, or at least parallel to the optical horizon 4, which is evaluated to correspond to an inclination angle of 0°, i.e. a zero roll about the vehicle's longitudinal axis.

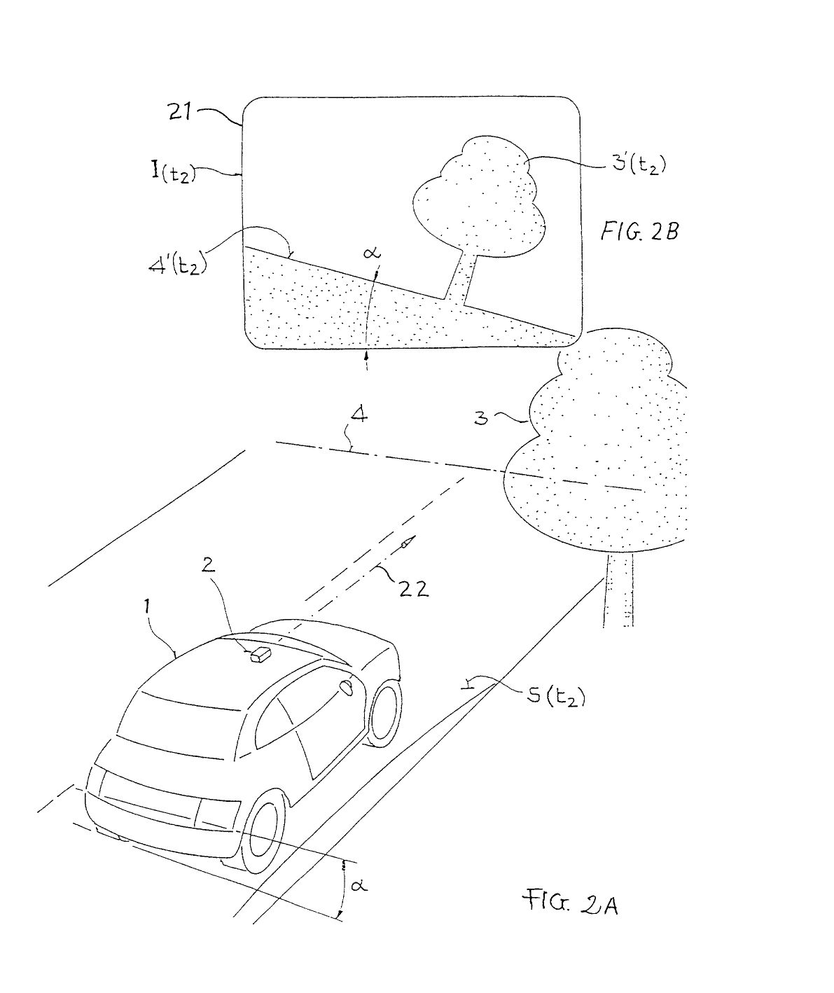

Now turning to FIGS. 2A and 2B, at time t(2) the vehicle 1 has driven onto a portion of the roadway 5(t2) that has a ramp or bump, which causes the right side of the vehicle to rise up with a tilt or inclination angle α relative to the left side of the vehicle 1, whereby the inclination angle α is to be understood relative to a level horizontal roadway or plane. In this situation at time t(2), the environmental image I(t2) acquired by the optical unit 2 still includes respective image points corresponding to the previously acquired image points representing the environmental object 3 and the natural horizon 4. However, at time t(2) these image points have moved to different positions within the field of view 21 of the image I(t2), relative to the positions of the corresponding image points at time t(1) in the image I(t1).

This motion of the image points arises from two factors and thus includes two motion components, namely first the linear motion of the vehicle 1 in the forward travel direction along the roadway 5 from time t(1) to time t(2), and secondly the change in the tilt or inclination angle of the vehicle 1 from 0 at time t(1) to α at time t(2). Thus, as long as the respective image points corresponding to respective environmental objects or features can be accurately and consistently identified in the successive images I(t1) at time t(1) and I(t2) at time t(2), it will be recognized that the positions of these image points have changed or moved with a component proportional to the inclination angle α. Thus, by comparing the positions of the image points of the prominent objects 3′ (t2) and the natural horizon line 4′ (t2) in the image I(t2) at time t(2), with the positions of the corresponding image points of the objects 3′ (t1) and horizon line 4′ (t1) in the image I(t1) at time t(1), the respective inclination angle α existing at time t(2), especially relative to the condition at time t(1), can be calculated. The inclination angle existing at time t(2) can also be absolutely calculated or determined in the same manner as discussed above for time t(1) in connection with FIGS. 1A and 1B. Namely, if a horizon line can be recognized in the image information, the determination of the inclination angle α is especially simple because it is merely necessary to determine the angle at which the image 4′ (t1 or t2) of the horizon 4 extends relative to a reference line in the field of view 21 of the respective image I, e.g. the longer axis of the rectangular field of view 21. This requires or assumes that the horizon is truly horizontal and can serve as a basis or reference for determining the inclination angle. If that is not the case, or if a natural horizon line cannot be recognized in the image information, then it is necessary to determine the angular change in the position of various image points such as the image 3′ of the object 3 at time t(2) relative to time t(1). This change in the angular position of the image information then corresponds to the change of the inclination angle α from time t(1) to time t(2), whereby the angle of inclination is first established, for example as α=0° at time t(1) as a reference angle.

Image recognition and processing software can determine the prominent image points in the respective image information of the acquired images, and can recognize the time variation of the positions of these image points from image to image, i.e. from time to time or from image frame to image frame. According to the invention, the software then further calculates the inclination angle α from the image information as described above, to an even greater precision. This calculation can be made finer or more precise by taking into account further factors, such as vehicle parameters, and especially the travel speed thereof, particularly in order to eliminate the image variations that arise due to the forward travel motion of the vehicle. Alternatively, the image variations arising from the forward travel of the vehicle can also be eliminated or filtered out based on an evaluation of several spaced-apart image points that undergo a mutually consistent or equal variation of their respective positions.

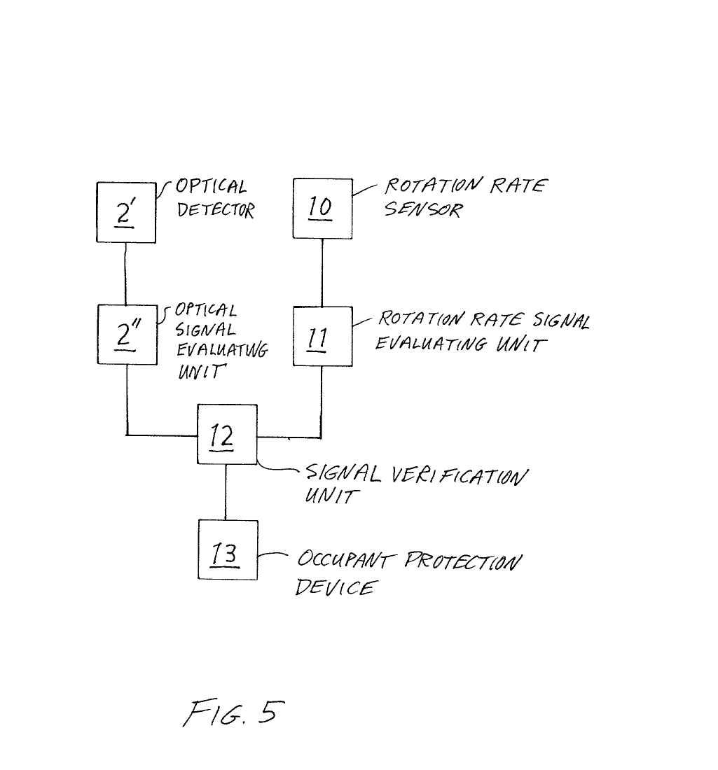

As further schematically illustrated in FIG. 5, the vehicle 1 is preferably additionally equipped with a rotation rate sensor 10 having a movable mass that is deflected due to any rotational acceleration (e.g. causing a tilting or inclination of the vehicle 1), to thereby emit a corresponding signal, which can be evaluated in a rotation rate signal evaluating unit 11 to provide a corresponding mechanically determined inclination angle signal. The image information provided by the optical detector 2′ of the optical unit 2 is provided to an optical signal evaluating unit 2″ of the optical unit 2 to ultimately provide an optically determined inclination angle signal. These two inclination angle signals are respectively provided from the optical signal evaluating unit 2″ and from the rotation rate signal evaluating unit 11 to a signal verification unit 12, which compares the two inclination angle signals, and then releases an occupant protection device trigger signal only if the two inclination angle signals are approximately equal to each other and exceed one or more prescribed inclination angle threshold values. The trigger signal is then provided to one or more occupant protection devices 13 such as airbags, belt tensioners, or a roll-bar, so as to deploy these devices.

Thereby, the signal verification unit 12 uses the optically determined inclination angle signal to verify the plausibility of the inclination angle that was determined by the rotation rate sensor 10 and its allocated evaluating unit 11. In this context, the two inclination angles are considered to be “approximately equal” if there is a difference of not more than 20° therebetween, or preferably not more than 10° therebetween, or alternatively when the difference therebetween is not more than 20% of the inclination angle determined by the rotation rate sensor 10. In this manner, if the inclination angle determined by the rotation rate sensor 10 seems implausible because it is substantially different from the inclination angle determined by the optical unit 2, then the occupant protection devices 13 will not be triggered.

As schematically represented in FIG. 1A, the optical unit 2, or especially the optical camera or detector thereof may be movably arranged to be rotatable about the yaw axis Y of the vehicle 1, so that the angle of view or detection angle thereof can be oriented in different directions as desired, for example to alternatively acquire image information from the lateral environment to the side of the vehicle. This can be useful and can be carried out especially in particular vehicle conditions or driving situations, for example when the vehicle undergoes a skid or a spin. It is further possible to provide a feedback coupling to an ESP system, so that obstacles can be maneuvered around. i.e. avoided.

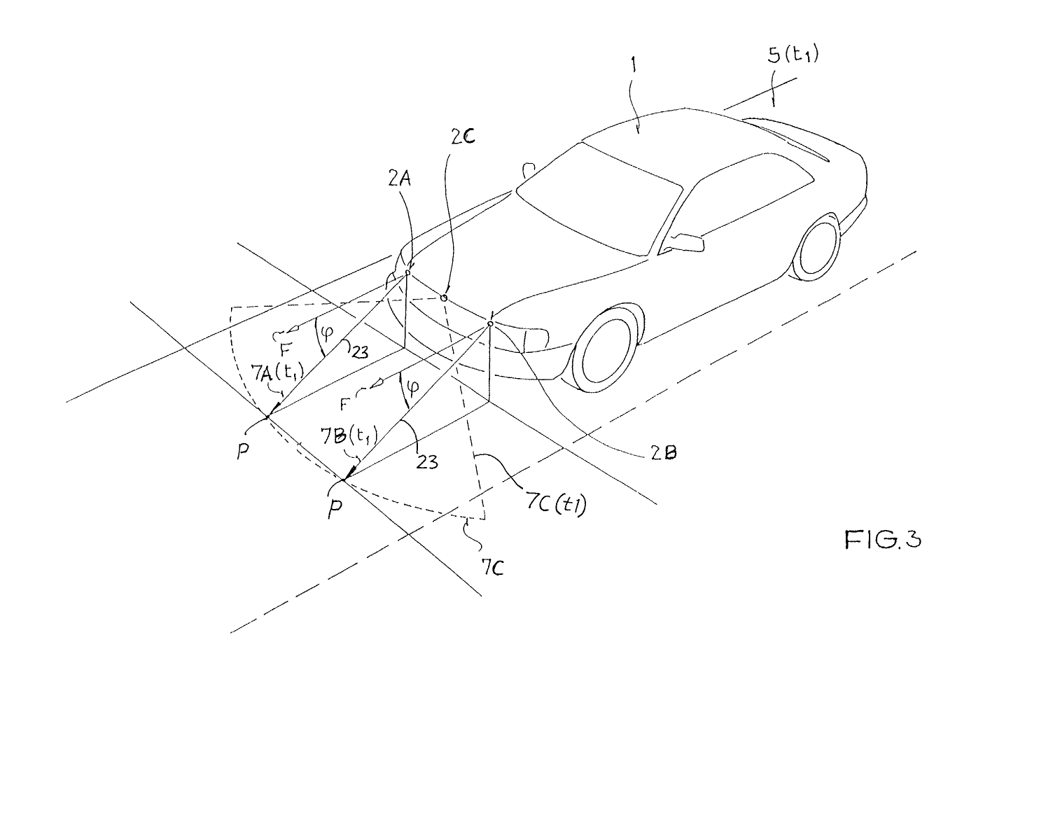

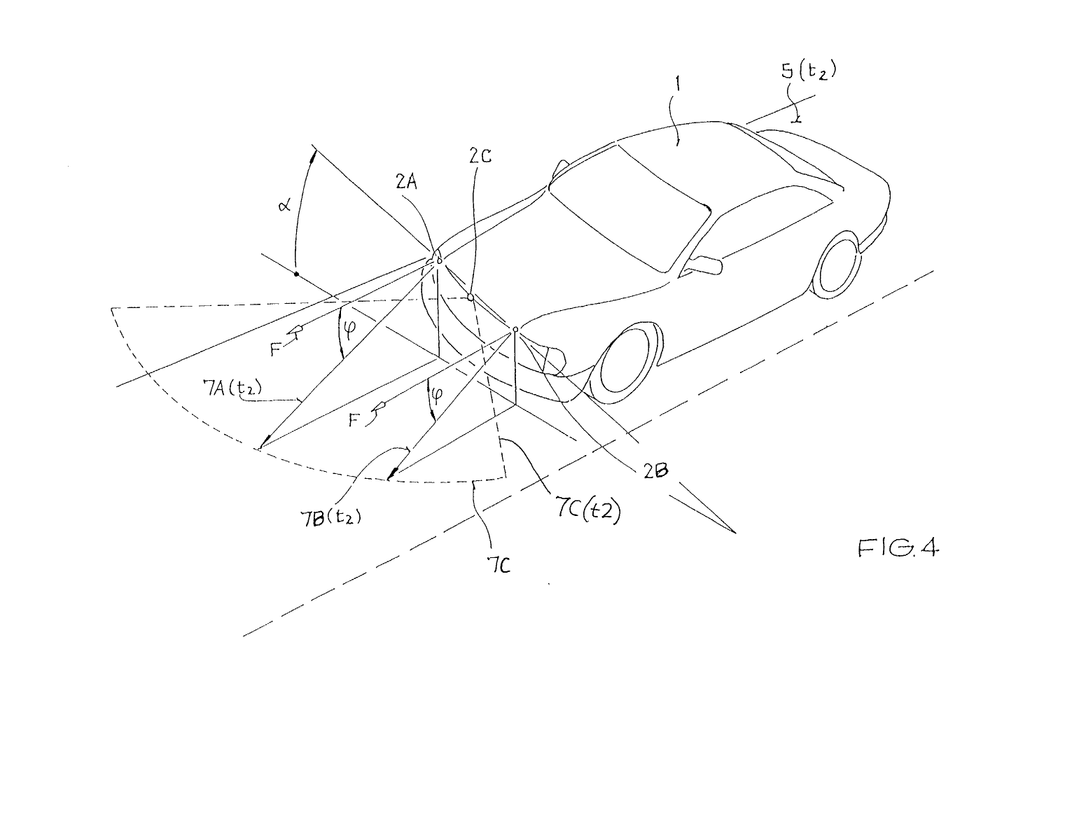

FIGS. 3 and 4 schematically represent a further embodiment of the inventive method and system. The system includes at least one optical sensor 2C or two optical sensors 2A and 2B, or three or more optical sensors 2A, 2B and 2C, preferably arranged at the front of the vehicle 1, with the respective line of sight or optical axis 23 of each of these optical sensors 2A, 2B, 2C oriented at a specified angle φ downwardly from a respective line F extending parallel to the longitudinal axis in the forward travel direction of the vehicle.

The detectors or sensors 2A, 2B and 2C may be active sensors such as infrared sensors or laser sensors that emit an active optical signal and then receive a reflected or return signal from the roadway 5 at the points P at which the lines of sight or optical axes 23 intersect the roadway 5. Even if these sensors are merely passive sensors, in any event they must be able to determine the spacing distance 7A, 7B, 7C between the respective sensor 2A, 2B, 2C and respective points P on the roadway 5 at the locations at which the respective optical axis or line of sight 23 of the respective sensor 2A, 2B, 2C intersects the roadway 5. For example, such sensors generate a three-dimensional optical image including both two-dimensional image information as well as distance values of the respective image points in the third dimension.

From the acquired distance information, namely distance values 7A(t1), 7B(t1) and 7C(t1) at time t(1) as shown in FIG. 3, and 7A(t2), 7B(t2) and 7C(t2) at time t(2) as shown in FIG. 4, the time variation of these spacing distances can then be calculated and used to determine an inclination angle, for example as follows.

As shown in FIG. 3, the optical axes 23 of the sensors 2A, 2B, 2C are oriented at an acute angle φ, i.e. an angle less than 90° down from the line F extending parallel to the longitudinal axis in the forward travel direction of the vehicle 1, such that the respective line of sight or optical axis 23 of each sensor 2A, 2B, 2C is oriented toward the roadway 5 at some distance in front of the vehicle 1, and is not oriented perpendicularly downward from the car directly onto the roadway under the car. This orientation angle φ of the sensors 2A, 2B, 2C is, for example, in a range from 20° to 60° below the forward travel direction F extending parallel to the longitudinal axis of the vehicle 1.

When the vehicle 1 is traveling on a level horizontal roadway 5(t1) at time t(1), the respective distances 7A(t1) and 7B(t1) as measured by the two sensors 2A and 2B are equal to each other and correspond to a nominal or rated distance value that pertains for normal level driving with an inclination angle of 0°. If plural sensors 2A, 2B are used, which each acquire a point image at the respective intersection point P of the optical axis 23 with the roadway 5, it is preferable that the angle φ of each sensor is the same, so that the distances 7A and 7B will all be the same for a level driving situation with an inclination angle of 0°. Thus, when these two measured distances 7A(t1) and 7B(t1) are equal, this corresponds to an inclination angle α of 0° (assuming the roadway surface is flat and planar). It is also preferable to acquire a greater number of image points, because thereby any deviations in the distance measurement that result from local unevenness of the roadway 5 can be more accurately distinguished from deviations in the distance measurement that result from an actual tilting or inclination of the vehicle, as will be described below. If only a single sensor 2C is used, this sensor preferably acquires a line image with a fan-shaped field of view on which the acquired image points all lie on the dashed curve 7C with a known distance function 7C(t1) relative to the location of the sensor 2C for the situation of level driving with a 0° inclination angle, whereby the respective distances of corresponding points symmetrically on opposite sides of the center line of the vehicle will be the same.

Now turning to FIG. 4, if the vehicle at time t(2) is tilted to an inclination angle α relative to a horizontal plane, the actual measured distances 7A(t2) and 7B(t2) measured by the two sensors 2A and 2B will differ from each other and will differ from the nominal or rated distance value, which is represented by the distances 7A(t1) and 7B(t2) as measured for level driving with a 0° inclination angle at time t(1) in FIG. 3, as discussed above. Similarly, if a single sensor 2C is used, the arc or curved line 7C(t2) on which the acquired image points lie will deviate from the nominal curved line for level driving 7C(t1) as shown in FIG. 3. From these differences representing the time variation of the measured distances of the image points between time t(1) and time t(2), or from the deviation of the measured distances from the specified nominal distances, the inclination angle α of the vehicle 1 at time t(2) can be calculated. Concretely, in the present example situation, the variation of the distance ratio 7A(t1)/7B(t1) to 7A(t2)/7B(t2) can be used to derive the inclination angle α of the vehicle relative to a level horizontal plane, for example the level roadway 5(t1) shown in FIG. 3.

As described above in connection with FIG. 5, the inclination angle determined in accordance with FIGS. 3 and 4 (just like the inclination angle determined in accordance with FIGS. 1A, 1B, 2A and 2B), can then further be used to carry out a plausibility verification of the inclination angle determined by the rotation rate sensor, in order to appropriately trigger one or more occupant protection devices in the vehicle.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

What is claimed is:

1. A method of rollover detection in a vehicle, comprising the following steps:
a) moving said vehicle in a forward travel direction in an environment outside of said vehicle;
b) using at least one optical detector device arranged in or on said vehicle, to optically acquire image information representing an image of said environment outside of said vehicle;
c) analyzing said image information to determine therefrom a first value of an inclination angle of said vehicle relative to a horizontal plane;
d) using a rotational rate sensor that is arranged in or on said vehicle and that includes a mass element which is mechanically deflectable responsive to a rotational acceleration, to generate a signal;
e) analyzing said signal to determine therefrom a second value of said inclination angle; and
f) comparing said second value with said first value to determine a difference value therebetween.

2. The method according to claim 1, further comprising a step of deploying an occupant protection device in said vehicle only if said difference value is less than a prescribed acceptable limit.

3. The method according to claim 2, wherein said prescribed acceptable limit is not more than 20°.

4. The method according to claim 2, wherein said step of deploying said occupant protection device is carried out further only if at least one of said first value and said second value exceeds a rollover threshold angle.

5. The method according to claim 2, wherein said step of deploying said occupant protection device is carried out further only if at least said second value exceeds a rollover threshold angle.

6. The method according to claim 1, wherein said step b) comprises optically acquiring plural image points included in said image information and representing objects and/or features in said environment, and wherein said step c) comprises analyzing a variation over time of respective positions of said image points in said image to determine therefrom said first value of said inclination angle.

7. The method according to claim 1, wherein said step b) comprises optically acquiring a horizon line included in said image information and representing a natural horizon in said environment, and wherein said step c) comprises analyzing an angular orientation of said horizon line relative to a reference orientation of said image.

8. The method according to claim 1, wherein said step b) further comprises orienting said at least one optical detector device respectively with an optical axis of a field of view thereof parallel to a longitudinal axis of said vehicle in said forward travel direction of said vehicle.

9. The method according to claim 1, wherein said step a) comprises moving said vehicle along a roadway included in said environment, wherein said step b) comprises acquiring plural image points on said roadway in front of said vehicle, and measuring respective distances from said at least one optical detector device to said plural image points, and wherein said step c) comprises at least one of analyzing a variation over time of said respective distances and respectively comparing said respective distances with a nominal distance pertaining for said inclination angle being zero, to determine therefrom said first value of said inclination angle.

10. The method according to claim 9, wherein said step b) further comprises orienting said at least one optical detector device respectively with an optical axis thereof extending at an acute angle below a line parallel to a longitudinal axis of said vehicle in a forward travel direction of said vehicle.

11. A system for rollover detection and occupant protection in a vehicle, comprising:
an optical detector device adapted to acquire optical image information from an environment outside of said vehicle and to determine therefrom a first value of an inclination angle of said vehicle relative to a horizontal plane;
a rotation rate sensor that includes a movable mass adapted to be mechanically deflected responsive to a rotational acceleration, and that is adapted to determine therefrom a second value of said inclination angle;
a plausibility verification unit that is connected to receive said first value from said optical detector device and said second value from said rotation rate sensor, and that includes a comparator arranged and adapted to compare said first value with said second value; and
an occupant protection device connected to an output of said plausibility verification unit.

12. A method of determining an inclination angle of a vehicle relative to a horizontal plane, comprising the following steps:
a) moving said vehicle in a forward travel direction along a roadway in an environment including environmental objects and/or environmental features outside of said vehicle;
b) using an optical imaging device arranged in or on said vehicle, to optically acquire image information representing an image of said environment and including plural image points representing said environmental objects and/or environmental features of said environment; and
c) analyzing a variation over time of respective positions of said image points in said image, to determine therefrom an inclination angle of said vehicle relative to a horizontal plane.

13. The method according to claim 12, wherein said environmental features include a natural horizon, said plural image points define a horizon image line representing said natural horizon, and said step c) comprises analyzing a variation over time of a position of said horizon image line in said image to determine therefrom said inclination angle.

14. The method according to claim 12, wherein said environmental objects and/or environmental features are passive pre-existing objects and/or passive pre-existing features and do not include active objects and/or active features that actively emit navigation or position information.

15. The method according to claim 12, wherein said environmental objects and/or environmental features include objects and features selected from buildings, road signs, roadway structures, trees, and a natural horizon.

16. The method according to claim 12, wherein said step c) of analyzing said variation comprises eliminating from said variation a first component of said variation that is caused by said moving of said vehicle in said forward travel direction so as to retain a second component of said variation that is caused by a variation of said inclination angle over time, and said analyzing then further comprises analyzing said second component of said variation to determine therefrom said inclination angle.

17. The method according to claim 16, wherein said eliminating of said first component comprises detecting spaced-apart image points among said plural image points representing said environmental objects and/or environmental features, which spaced-apart image points respectively all have a common variation over time of their respective locations, and using said common variation to distinguish between said first component and said second component.

18. The method according to claim 16, wherein said eliminating of said first component comprises sensing a speed of said moving of said vehicle, and then filtering or modifying said image information over time to eliminate said first component dependent on said speed of said vehicle.

19. The method according to claim 12, wherein said step b) further comprises orienting said optical imaging device with a field of view thereof encompassing a longitudinal axis of said vehicle in said forward travel direction.

20. The method according to claim 19, wherein said optical imaging device is oriented with an optical axis thereof extending parallel to said longitudinal axis in said forward travel direction.

21. The method according to claim 12, wherein said optical imaging device has a field of view spanning an optical detecting angle, and further comprising rotating said optical detecting angle about a yaw axis of said vehicle extending orthogonally to a longitudinal axis and to a transverse axis of said vehicle.

22. A method of determining an inclination angle of a vehicle relative to a horizontal plane, comprising the following steps:
a) moving said vehicle in a forward travel direction along a roadway;
b) using at least one optical detector device arranged on or in said vehicle, to measure respective distances from said at least one optical detector device to plural points on said roadway in front of said vehicle in said forward travel direction; and
c) analyzing said respective distances to determine therefrom said inclination angle.

23. The method according to claim 22, wherein said analyzing in said step c) comprises analyzing a variation over time of said respective distances.

24. The method according to claim 22, wherein said analyzing in said step c) comprises comparing said respective distances with one another.

25. The method according to claim 22, wherein said analyzing in said step c) comprises respectively comparing said respective distances with one or more nominal distances that pertain for said inclination angle being zero, and then determining an actual measured value of said inclination angle based on respective differences between said respective distances and said one or more nominal distances.

26. The method according to claim 22, wherein said plural points on said roadway are respectively located at respective intersections of said roadway with lines of sight extending from said at least one optical detector device to said plural points, with respective fixed prescribed acute angles (φ) respectively formed between said lines of sight and at least one line extending respectively from said at least one optical detector device parallel to a longitudinal axis of said vehicle.

27. The method according to claim 26, wherein said fixed prescribed acute angles (φ) are each respectively in a range from 20° to 60°.

28. A method of optically monitoring an environment outside of a vehicle, comprising the following steps:
a) moving said vehicle in a forward travel direction on a roadway in said environment;
b) using an optical detector device arranged in or on said vehicle, to optically acquire image information representing an image of said environment outside of said vehicle;
c) carrying out at least one of a first analyzing of said image information acquired using said optical detector device to recognize an obstacle on said roadway in front of said vehicle in said forward travel direction, and a second analyzing of said image information acquired using said optical detector device to measure a spacing distance between said vehicle and another vehicle traveling ahead of said vehicle in said forward travel direction on said roadway; and
d) carrying out a third analyzing of said image information acquired using said optical detector device to determine therefrom an inclination angle of said vehicle relative to a horizontal plane.
